(19) United States
(12) Patent Application Publication
(10) Pub. No.: US 2015/0288857 A1
(43) Pub. Date: Oct. 8, 2015

(54) MOUNT THAT FACILITATES POSITIONING AND ORIENTING A MOBILE COMPUTING DEVICE

(71) Applicant: Microsoft Corporation, Redmond, WA (US)

(72) Inventors: Jonathan Fay, Woodinville, WA (US); Daniel Fay, Sammamish, WA (US)

(73) Assignee: Microsoft Corporation, Redmond, WA (US)

(21) Appl. No.: 14/246,587

(22) Filed: Apr. 7, 2014

(51) Int. Cl. H04N 5/225; H04N 5/232; G03B 17/56

(52) U.S. Cl. CPC H04N 5/2251; G03B 17/561; H04N 5/23238

(57) ABSTRACT

Described herein are various technologies pertaining to positioning and/or orienting a mobile computing device through utilization of a mount. The mobile computing device uses internal sensors to generate control signals, wherein a control signal indicates a direction of movement of the mobile computing device and a velocity of the movement. The control signals are transmitted to the mount, which positions and/or orients the mobile computing device according to the direction of the movement and the velocity of the movement indicated in the control signal.

### BACKGROUND

A camera mount (also referred to as a rig) is a device that is configured to stabilize a camera, thereby mitigating blur in an image captured by the camera that is caused by movement of the camera. Camera mounts have recently been developed to operate in conjunction with cameras in an automated fashion, where a mount is configured to position and/or orient a camera at desired positions and/or orientations over time. For example, a camera mount and a camera can operate in conjunction to automatically generate a panoramic image. This type of camera mount tends to be heave, costly, and energy inefficient.

With more detail, when generating a panoramic image, a camera (e.g., a Single Lens Reflex (SLR) camera) and the mount act in conjunction as follows: a user of the SLR camera secures the SLR camera onto the mount, and electrically couples the SLR camera with the mount. For example, the SLR camera and the mount may each be configured with a respective universal serial bus (USB) interface, where data is transmitted between the camera and the mount over the USB connection. The user may then use the mount to position and/or orient the SLR camera at an initial position. Thereafter, the user indicates to the SLR camera and/or the mount that a panoramic image is to be generated (e.g., starting from the initial position, and then panning and/or tilting in a direction specified by the user). Responsive to receiving this indication, the SLR camera captures an initial image and transmits a signal to the mount that indicates that the image has been captured. A processor in the mount receives the signal from the SLR camera, and responsive to receipt of the signal, the processor (through execution of control logic) drives actuators in the mount to reposition and/or re-orient the SLR camera. The processor of the mount includes hardware and software to control the repositioning and/or re-orienting of the mount, wherein the hardware includes positional and/or inertial sensors, and the software includes the above-mentioned control logic.

Responsive to the mount determining that the mount has appropriately repositioned and/or re-oriented the camera, the mount transmits a signal to the SLR camera that instructs the SLR camera to capture another image. The SLR camera, upon receipt of such signal, captures an image. The sequence described above repeats until the SLR camera has captured a sufficient number of images to generate the panoramic image.

From the above, it can be ascertained that the mount includes a significant amount of electronics, which consume power (e.g., from batteries of the mount) and drives the price of the mount upwards. For example, as noted above, the mount includes a chipset that facilitates establishing a communications channel between the mount and the camera, positional and/or inertial sensors, a processor that executes control logic based upon data output by the sensors, etc. Thus, conventionally, a mount that is configured to act in conjunction with a camera to automatically generate panoramic images conventionally costs several hundred dollars, which is outside of the price range for many hobbyists.

### SUMMARY

The following is a brief summary of subject matter that is described in greater detail herein. This summary is not intended to be limiting as to the scope of the claims.

Various technologies pertaining to a relatively low-cost camera mount that is employable to facilitate automatic positioning and/or orienting of a mobile computing device are described herein. Also described herein are various technologies pertaining to controlling operation of the mount through use of the mobile computing device. An exemplary camera mount is powered by a power source other than the device being positioned and/or oriented by the camera mount. For example, the camera mount can be powered by batteries, by solar power, by way of a wall outlet, etc. The camera mount further includes a mount communications interface that is configured to receive command signals from a mobile computing device that is stably affixed to the camera mount. The mount communications interface can be a wireless communications interface, such as Wi-Fi, Bluetooth, near-field communications (NFC), or the like. In another exemplary embodiment, the mount communications interface can be an audio-in port, wherein the command signals referenced above can be encoded as audio signals emitted from the mobile computing device.

In operation, the mount receives the control signal from the mobile computing device by way of the mount communications interface. The control signal indicates a direction of movement of the mobile computing device (e.g., a direction of a pan and/or a direction of a tilt of the mobile computing device), and further optionally indicates a velocity of the movement of the mobile computing device. A microcontroller of the mount receives the control signal and drives a motor in accordance with the direction (and velocity) indicated in the control signal. In such an embodiment, the mount need not be configured with positional and/or inertial sensors, and further the microcontroller need not execute control logic; rather, the mobile computing device controls the mount, and the mount acts as a slave to the mobile computing device.

Thus, the mobile computing device executes control logic to generate control signals, and the command signals are transmitted to the mount by the mobile computing device. In an example, the mobile computing device can be a mobile telephone, a tablet (slate) computing device, a phablet computing device (e.g., a mobile telephone with a screen diagonal of between five inches and eight inches), a camera (e.g., a SLR camera), or the like. These types of mobile computing devices are manufactured to include positional and/or inertial sensors, such as, but not limited to, a global positioning system (GPS) sensor, an accelerometer, a gyroscope, a velocity sensor, etc. Furthermore, these types of mobile computing devices are typically equipped with a digital camera, with ever-increasing resolution.

In an exemplary embodiment pertaining to the mobile computing device generating a control signal, a processor of the mobile computing device receives a sensor signal output by a sensor therein, and determines current position and/orientation of the camera of the mobile computing device based upon the sensor signal. The processor of the mobile computing device can execute control logic based upon the determined position and/or orientation (and a desired position and/or orientation), generates the control signal, and transmits the control signal to the mount. The sensor continues to generate the sensor signal, which indicates position and/or orientation change as the mount repositions and/or reorients the mobile computing device. The processor of the mobile computing device generates updated control signals as the sensor signals indicate change in position and/or orientation of the mobile computing device.

In an exemplary embodiment, the user may wish to employ the mobile computing device and the mount to autonomously or semi-autonomously generate a panoramic image. The user can affix the mobile computing device to the mount, and can communicatively couple the mobile computing device with the mount (e.g., by electrically coupling the audio-out port of the mobile computing device with an audio-in port of the mount). The user can cause the mount to position and orient the camera at an initial position and/or orientation, and can instruct the mobile computing device to generate a panoramic image.

The mobile computing device, based upon data output by sensors therein, can compute its current position and/or orientation, and can cause a camera of the mobile computing device to capture an initial image. Responsive to the initial image being captured, the mobile computing device can compute a desired position and/or orientation of the camera of the mobile computing device (e.g., where a next image is to be captured). Based upon the desired position and/or orientation of the mobile computing device, the mobile computing device can generate a control signal that indicates direction of movement of the mobile computing device (e.g., direction of pan and/or direction of tilt) and velocity of movement of the mobile computing device in the indicated direction. The mobile computing transmits the control signal (e.g., encoded as an audio signal) to the mount. The mount receives the control signal, and a microcontroller in the mount generates a drive signal (e.g., a pulse-width modulation (PWM) signal) for a motor based upon the control signal.

The motor, responsive to receiving the drive signal, rotates in a direction based upon the direction indicated in the command signal (and based upon the velocity indicated in the command signal). A mechanical linkage is driven by the motor and is mechanically coupled to the mobile computing device, such that the motor acts to move the mobile computing device (by way of the mechanical linkage) in accordance with the command signal. The mobile computing device monitors its position and/or orientation and transmits updated control signals as the position and/or orientation of the mobile computing device changes. The mobile computing device determines when images are to be captured, as well as when the mobile computing device is appropriately positioned. Thus, the intelligence resides at the mobile computing device, decreasing an amount of power needed to operate the mount relative to conventional mounts, and decreasing costs of the mount relative to conventional mounts.

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF THE DRAWINGS

FIG. 1 illustrates a mobile computing device positioned in a mount.

FIG. 2 is a functional block diagram of the mount.

FIG. 3 is a functional block diagram of the mobile computing device.

FIG. 4 is a flow diagram that illustrates an exemplary methodology, executed by a mount, to position a mobile computing device at a desired position and/or orientation.

FIG. 5 is a flow diagram that illustrates an exemplary methodology for transmitting a control signal to a mount.

FIG. 6 is a flow diagram illustrating an exemplary methodology for constructing a panoramic image.

FIG. 7 is an exemplary computing system.

### DETAILED DESCRIPTION

Various technologies pertaining to a camera mount and a mobile computing device are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Further, as used herein, the terms “component” and “system” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices. Further, as used herein, the term “exemplary” is intended to mean serving as an illustration or example of something, and is not intended to indicate a preference.

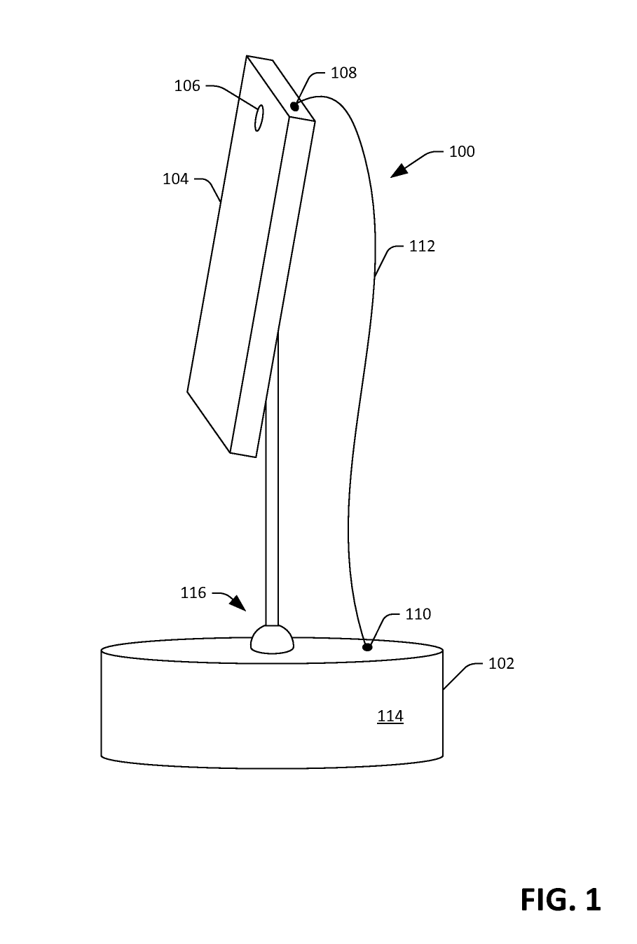

With reference now to FIG. 1, an exemplary system 100 that facilitates positioning and/or orienting a mobile computing device is illustrated. The system 100 includes a mount (which also may be referred to as a rig) 102. The system 100 further comprises a mobile computing device 104, which may be a mobile telephone, a portable camera, a tablet (slate) computing device, a phablet computing device, a wearable computing device, or the like. The mobile computing device 104 includes a camera (represented by reference numeral 106).

The mount 102 is configured to receive the mobile computing device 104 and stably hold the mobile computing device 104. Accordingly, the mount 102 can be particularly well-suited to facilitate capturing a high-quality image, as stabilization of the mobile computing device 104 provided by the mount 102 results in prevention of blur (caused by motion of the camera 106) in an image. Further, as will be described herein, the mount 102 can include a motor that, when the mobile computing device 104 is affixed to the mount 102, effectuates alteration of position and/or orientation of the mobile computing device 104 (e.g., relative to a reference position and/or orientation). For example, the mount 102 can be configured to tilt the mobile computing device 104, pan the mobile computing device 104, or tilt and pan the mobile computing device 104.

The mount 102 and the mobile computing device 104 can be in communications with one another by way of a suitable communications interface and/or protocol. For example, the mount 102 and the mobile computing device 104 can include respective wireless chipsets, such that the mobile computing device 104 can transmit data to the mount by way of a suitable wireless protocol, such as Wi-Fi, Wi-Fi direct, Bluetooth, near-field communications (NFC), etc. In another example, the mount 102 and the mobile computing device 104 can include chipsets that facilitate wired communications and/or powering of the mount 102 by way of the mobile computing device 104, such as chipsets that facilitate communications by way of a universal serial bus (USB) connection, a FireWire connection, etc. In yet another exemplary embodiment, and as shown in FIG. 1, the mobile computing device 104 can transmit data to the mount 102 by way of an audio channel. With more particularity, the mobile computing device 104 includes an audio-out port 108 and the mount 102 can include an audio-in port 110, wherein an electrical connector 112 is configured to carry audio signals emitted from the audio-out port 108 to the mount 102 by way of the audio-in port 110. As will be described in greater detail below, control signals generated by the mobile computing device 104 for controller operation of the mount 102 can be encoded as audio signals and transmitted from the mobile computing device 104 to the mount 102 by way of the audio ports 108 and 110 and the electrical connector 112.

In an exemplary embodiment, the mount 102 and the mobile computing device 104 can act in conjunction to autonomously or semi-autonomously generate a panoramic image. In another example, the mount 102 and the mobile computing device 104 can be applied in a security setting, wherein the mount 102 and the mobile computing device 104 act in conjunction to monitor a region. In another example, the mount 102 and the mobile computing device 104 can act in conjunction to position/orient the mobile computing device 104 based upon instructions received from another computing device (e.g., another mobile computing device, a video game controller, etc.) by way of a suitable wireless connection.

With more detail pertaining to the mount 102, the mount 102 can be a relatively small (and thus portable) mount that facilitates autonomous or semi-autonomous positioning and/or orienting of the mobile computing device 104 (e.g., to generate panoramic images). For example, the mount 102 can include a base 114, which can comprise a pair of relatively inexpensive servo motors (e.g., a first servo motor that effectuates panning of the mobile computing device 104 and a second servo motor that effectuates tilting of the mobile computing device 104). The base 114 of the mount 102 can also comprise a microcontroller that is configured to drive the servo motors (e.g., based upon a control signal output by the mobile computing device 104).

The mobile computing device 104 includes sensors that are typically included in mobile computing devices (e.g., particularly mobile telephones), wherein the sensors can include a positional sensor (e.g., a global positioning system sensor), an inertial sensor (e.g., an accelerometer, a velocity sensor, a gyroscope, etc.). The mobile computing device 104 further includes a processor that executes control logic, wherein the control logic can take a sensor signal as input and generate control signals based upon the sensor signal. In an example, the mobile computing device 104 can compute a current position and/or orientation of the mobile computing device 104, and can further compute a desired position and/or orientation of the mobile computing device 104 (e.g., to facilitate appropriately positioning and/or orienting the camera 106). Responsive to computing these positions and/or orientations, the mobile computing device 104 can generate a control signal, wherein the control signal indicates a direction of movement of the mobile computing device 104 (and optionally a velocity of movement of the mobile computing device 104) that facilitates positioning and/or orienting the mobile computing device 104 at the desired position and/or orientation.

An exemplary operation of the system 100 is now set forth. The mobile computing device 104 generates a control signal as described above, and transmits the control signal to the mount 102 by way of the communications interface referenced above (e.g., as shown in FIG. 1, by way of the electrical connector 112). The microcontroller of the mount receives the control signal and, for example, identifies a motor that can effectuate movement of the mobile computing device 104 in the direction indicated in the control signal. Responsive to identifying the motor, the microcontroller outputs a drive signal to the identified motor, wherein the drive signal is based upon the direction of movement (and velocity) indicated in the control signal. The motor drives a mechanical linkage 116, resulting in alteration of position and/or orientation of the mobile computing device 104. The mobile computing device 104 generates an updated control signal based upon such alteration, and transmits the updated control signal to the mount 102.

It can thus be ascertained that the mobile computing device 104 uses output of its own sensors to monitor its position and to control motors of the mount 102. This control approach leverages equipment that is typically included in mobile computing devices, thereby allowing the mount 102 to be manufactured without such equipment (and therefore at less cost than conventional mounts). For example, the mount 102 need not include positional or inertial sensors, as the mount 102 acts as a slave to the mobile computing device 104. Further, as the mount 102 includes less componentry than conventional mounts, the mount 102 can be manufactured to weigh less (and therefore be more portable) than conventional mounts, and further consumes less power when compared to power consumed by conventional mounts.

Various applications of the system 100 are now set forth. As indicated above, the system 100 may be particularly well-suited for autonomous or semi-autonomous generation of panoramic images. To that end, the mobile computing device 104 may have installed thereon a computer-executable program that facilitates generation of panoramic images, wherein the computer-executable program can include an image stitcher. In operation, a user can secure the mobile computing device 104 onto the mount 102. For example, the mount 102 may include a clasp, a slot, magnets, or the like to secure the mobile computing device 104 onto the mount 102. In an exemplary embodiment, the user may initially provide input that results in positing and orienting the mount at a desired initial position and orientation, such that the field of view (FOV) of the camera 106 includes a desirably captured initial scene. For instance, the mount 102 may include exposed controls (e.g., buttons, sliders, a touch-sensitive screen, . . . ) that allows the user to effectuate panning and/or tilting of the mobile computing device 104 when the mobile computing device 104 is secured to the mount 102.

Responsive to the mobile computing device 104 being initially positioned, the mobile computing device 104 can receive an instruction from the user that a panoramic image is to be created. Responsive to receiving this instruction, the processor of the mobile computing device 104 can ascertain the position and/or orientation of the mobile computing device 104, and can cause the camera 106 to capture an initial image. The computer-executable program installed on the mobile computing device 104 for generating panoramic images can compute a next position and/or orientation of the mobile computing device 104, such that the camera 106 (when the mobile computing device 104 is at the next position and/or orientation) can capture an image that can be stitched with previously captured images to generate the panoramic image. Based upon the current position and/or orientation and the next position and/or orientation, the mobile computing device 104 can generate a control signal that indicates a direction that the mobile computing device 104 is to be panned and/or tilted, as well as, for instance, a velocity of such movement.

The control signal is transmitted to the mount 102 by way of the communications interface (e.g., the electrical connector 112), and the microcontroller in the mount 102 receives the control signal and outputs a drive signal to a motor based upon the control signal. The motor drives the mechanical linkage 116 based upon the drive signal, thus facilitating movement of the mobile computing device 104 towards the next position and/or orientation. For example, the motor may be a panning motor, which when driven by the microcontroller, causes the mechanical linkage 116 to rotate, thereby panning the mobile computing device 104 in the direction indicated in the control signal. The mobile computing device 104 continues to monitor its own position and/or orientation, and sends command signals to the mount 102 based upon the monitored position and/or orientation. When the mobile computing device 104 detects that it has reached the next position and/or orientation, the camera 106 can be caused to capture another image. This process repeats until an appropriate number of images have been captured by the camera 106, and the computer-executable program can stitch the images to form the panoramic image.

In another exemplary embodiment, the system 100 is particularly well-suited for centering an object in the FOV of the camera 106. For instance, the system 100 can be configured to assist a user in capturing a photo that includes several individuals (e.g., a family photo) or a self-portrait. With more particularity, a user can secure the mobile computing device 104 onto the mount 102, and can generally position and orient the mobile computing device 104 as desired, such that the FOV of the camera 106 encompasses a region where the user (and optionally others) are to pose for a photograph. Once the participants in the photograph are positioned in the FOV of the camera 106 and are relatively stationary, the mobile computing device 104 can cause the camera 106 to capture an image and analyze such image to identify faces in the image, and to further identify a location in the image that corresponds to a central point of the participants in the image. The mobile computing device 104 can then generate a control signal that indicates a direction that the mobile computing device 104 is to be moved (oriented) to cause the participants to be generally centrally positioned in the FOV of the camera 106. In this example, the camera 106 can be the sensor, wherein output of the camera 106 is used to compute the control signals. The mount 102 receives the control signal, and the motor of the mount is driven based upon the control signal. The mobile computing device 104 continues to capture images and analyze such images until the participants are generally centrally located in the FOV of the camera 106.

In yet another exemplary application, the system 100 is particularly well-suited for tracking moving object that passes through the FOV of the camera 106. This may be particularly beneficial, for example, when capturing photographs of nature (e.g., an eagle flying through the air) or in a security application. In an exemplary security application, for example, the mobile computing device 104 and the mount 102 can act in conjunction to track a person walking through a region being monitored. For instance, the mobile computing device 104 can be secured onto the mount 102, and the mobile computing device 104 can transmit control signals to the mount 102 that cause the mount 102 to pan the mobile computing device 104, such that the region is monitored. The mobile computing device 104 can be configured with a computer-executable program that causes the camera 106 to capture images, and further analyzes the images to identify moving objects (e.g., people) therein. When a moving object is detected in images, direction and velocity of the moving object can be determined by comparing images captured at different times.

Based upon the direction and velocity of movement of the moving object, the mobile computing device 104 can generate a control signal and transmit the control signal to the mount 102, wherein the control signal identifies the direction that the mobile computing device 104 is to be moved to track the moving object, and wherein the control signal can further identify the velocity of the movement. The mount 102 then pans and/or tilts the mobile computing device 104 based upon the control signal. The mobile computing device 104 continues to capture images and generate control signals based upon the captured images, such that the moving object can be tracked over time. Other applications are also contemplated.

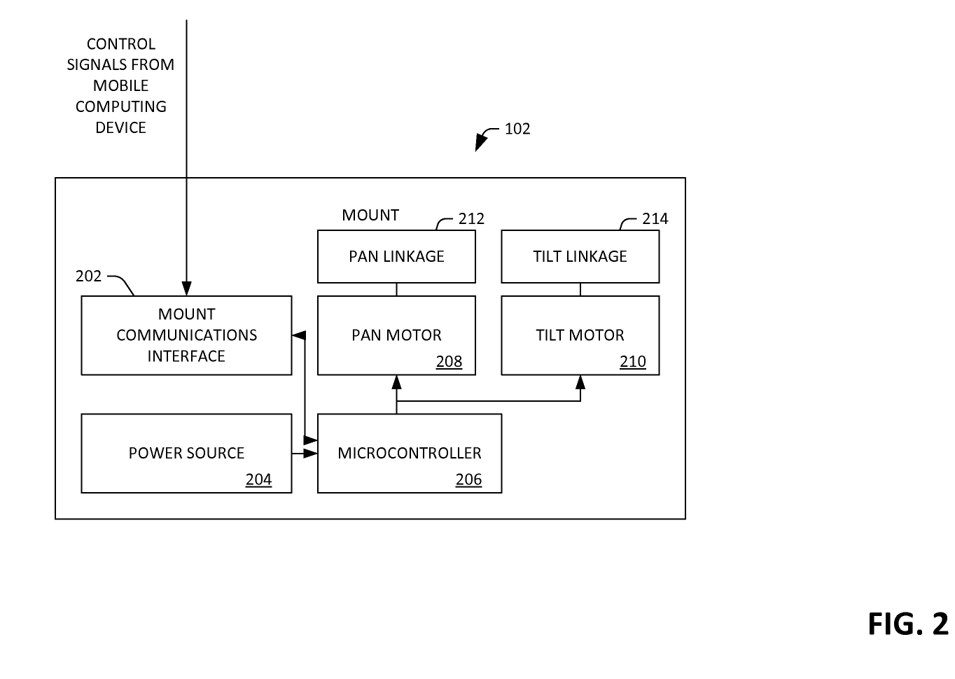

With reference now to FIG. 2, a functional block diagram of the mount 102 is illustrated. The mount 102 includes a mount communications interface 202 that is configured to receive control signals output by the mobile computing device 104. For example, the mount communications interface 202 can be or include a wireless chipset that supports a suitable wireless communications protocol, such as Bluetooth, Wi-Fi, Wi-Fi direct, NFC, etc. In another example, the mount communications interface 202 can or include a USB interface, some other serial interface, a FireWire interface, etc. In yet another example, the mount communications interface 202 can be an optical interface that can receive optical signals emitted from the mobile computing device 104. In yet another example, the mount communications interface 202 can include an audio-in port that receives audio signals emitted by the mobile computing device 104, wherein the command signal is encoded in an audio signal.

The mount 102 further includes a power source 204 that can power the mount communications interface 202. For example, the power source 204 may be a battery (e.g., a rechargeable battery), a photovoltaic cell that generates energy responsive to being irradiated with radiation of a particular spectrum, an interface to a wall outlet, etc. In another exemplary embodiment, rather than including the power source 204, componentry of the mount 102 can be powered by the mobile computing device 104 by way of the mount communications interface 202.

The mount 102 further includes a microcontroller 206 that is powered by the power source 204 and is in communications with the mount communications interface 202. The microcontroller 206 can receive a control signal generated by the mobile computing device 104 by way of the mount communications interface 202.

As indicated above, a control signal output by the mobile computing device 104 can indicate the direction of movement (e.g., a direction of pan or a direction of tilt) and (optionally) a velocity of the movement. The direction of the movement can be one of 1) pan left; 2) pan right; 3) tilt up; or 4) tilt down (or some combination of pan and tilt) Further, in an exemplary embodiment, the velocity of the movement may one of a predefined number of discrete velocities (e.g., very slow, slow, fast, or very fast).

The mount 102 includes a pan motor 208 and a tilt motor 210 that are respectively driven by the microcontroller 206. For example, the microcontroller 206 can receive a control signal that indicates that the mobile computing device 104 is to pan left at a velocity of “very slow.” The microcontroller 206 can generate a drive signal (e.g., a PWM signal) based upon such control signal, and direct the drive signal to the pan motor 208. The pan motor 208 then rotates in a direction based upon the drive signal and at a velocity based upon the drive signal.

The mount 102 also includes a pan linkage 212 and a tilt linkage 214 that are driven by the pan motor 208 and the tilt motor 210, respectively. The pan linkage 212, when driven by the pan motor 208, causes the mobile computing device 104 to pan. Likewise, the tilt linkage 214, when driven by the tilt motor 210, causes the mobile computing device 104 to tilt. While the mount 102 has been described as panning and tilting the mobile computing device 104 separately, it is to be understood that the pan motor 208 and the tilt motor 210 can drive the pan linkage 212 and the tilt linkage 214 simultaneously, such that the mobile computing device 104 can simultaneously be panned and tilted.

In an exemplary embodiment, when the command signal is encoded in an audio signal, the microcontroller 206 can include (or be in communication with) a filter circuit (e.g., a resistor-capacitor network) that acts to extract the command signal from the audio signal. For instance, the audio signal can comprise two audio channels: 1) a left channel; and 2) a right channel. One of the left channel or right channel can carry a data signal, while the other of the left channel or right channel can carry a clock signal. The filter circuit can generate a transistor-transistor logic (TTL) signal from the received audio signal (e.g., based upon the data signal and the clock signal), wherein the TTL signal represents the command signal generated at the mobile computing device 104. Accordingly, in such an embodiment, the microcontroller 206 can blindly listen to the audio-in port 110 to receive and decode command signals.

Furthermore, the pan motor 208 and the tilt motor 210 can be servo motors that smoothly slue at a velocity indicated in the control signal. For example, this can be accomplished by modifying a conventional servo motor by removing a stop pin, and by causing the potentiometer of the servo motor to report that it is positioned at a center position. This type of modification allows for full rotation of the servo motor, and further allows for direction of slue to be controlled as a function of being left or right of the center position. Thus, the pan motor 208 and/or the tilt motor 210 can be variable speed, geared servo motors.

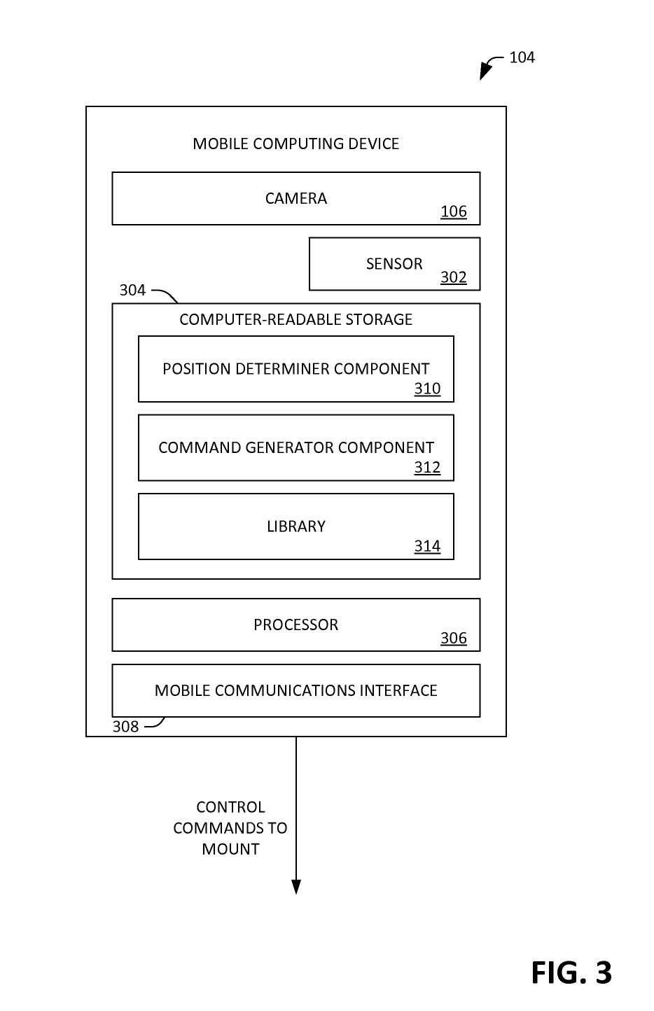

Referring now to FIG. 3, a functional block diagram of the mobile computing device 104 is illustrated. The mobile computing device 104 includes the camera 106. Additionally, the mobile computing device 106 includes a sensor 302, which can be a positional sensor, an inertial sensor, or other suitable sensor that outputs a sensor signal upon which control signals may be desirably based. The mobile computing device 104 also includes computer readable storage 304, which can be integral computer readable memory, a flash memory drive, a hard drive, or the like. The mobile computing device 104 also includes a processor 306 that can execute instructions in the computer readable storage 304. Further, the mobile computing device 300 includes a mobile communications interface 308 that facilitates transmission of control signals to the mount 102.

The computer readable storage 304 includes a position determiner component 310. The position determiner component 310 is configured to receive a sensor signal output by the sensor 302 and compute a position and/or orientation of the mobile computing device 104 (and thus, the camera 106) based upon the sensor signal. It is to be understood that the position determiner component 310 can receive signals output by multiple sensors in the mobile computing device 104 to compute the position and/or orientation of the mobile computing device 104. It is to be understood that the position determiner component 310, in an exemplary embodiment, can compute an absolute position and/or orientation of the mobile computing device 104. In another exemplary embodiment, the position determiner component 310 can compute a position and/or orientation of the mobile computing device 104 relative to a previous position and/or orientation of the mobile computing device 104.

The computer readable storage 304 can also include a command generator component 312 that is configured to generate control signals for transmission to the mount 102 (e.g., based upon a position and/or orientation computed by the position determiner component 310). In an exemplary embodiment, the command generator component 312 can select control signals from a predefined library 314 of control signals. Each control signal in the library 314 can indicate, for example, a motor that is to be controlled based upon the control signal, a direction that the motor is to slue, and a velocity at which the motor is to slue. In an exemplary embodiment, the library 314 may include a plurality of audio files, wherein the command generator component 312 can select an audio file from amongst the plurality of audio files and cause a corresponding audio signal to be transmitted to the mount 102. When the mobile computing device 104 is positioned and/or oriented as desired, the command generator component 312 need not output a control signal—as the mount 102 maintains its position when a control signal is not received. It can be ascertained that the mobile computing device 104 can control the mount 102 without receiving feedback from the mount 102. Rather, the feedback is received from the sensor 302 on the mobile computing device 104.

Further, while not shown, the computer-readable storage 304 can include the above-mentioned computer-executable program that is configured to generate a panoramic image. That is, the computer-executable program, when executed by the processor 306, causes the camera 106 to capture images that can stitched to generate a panoramic image. Likewise, the computer-readable storage can include a computer-executable security application that is configured to cause the mobile computing device 104 to monitor a particular region.

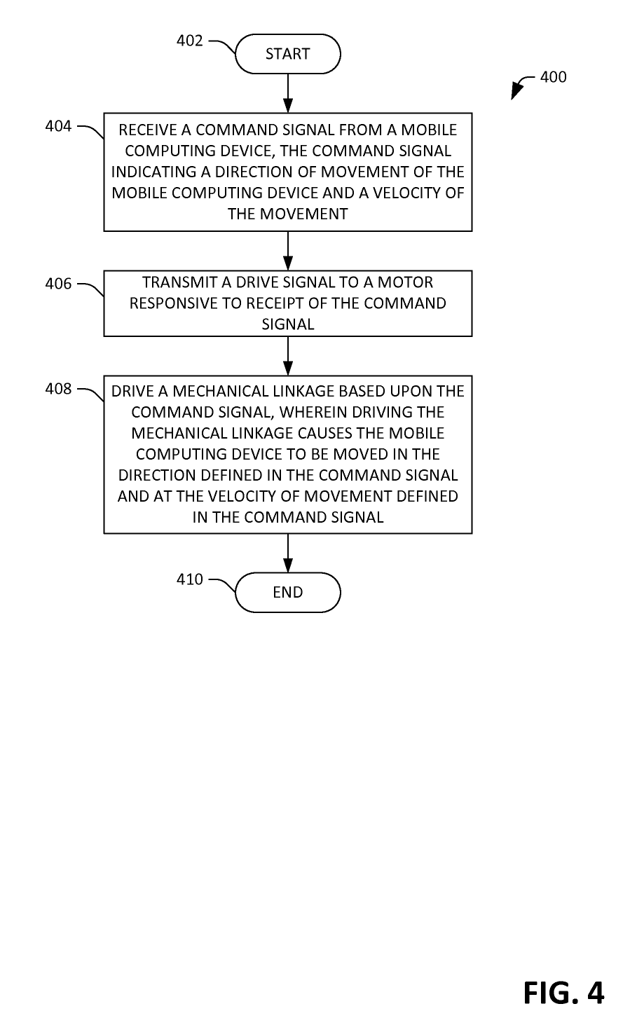

FIGS. 4-6 illustrate exemplary methodologies relating to positioning and/or orienting a mobile computing device through utilization of a stabilizing mount. While the methodologies are shown and described as being a series of acts that are performed in a sequence, it is to be understood and appreciated that the methodologies are not limited by the order of the sequence. For example, some acts can occur in a different order than what is described herein. In addition, an act can occur concurrently with another act. Further, in some instances, not all acts may be required to implement a methodology described herein.

Moreover, the acts described herein may be computer-executable instructions that can be implemented by one or more processors and/or stored on a computer-readable medium or media. The computer-executable instructions can include a routine, a sub-routine, programs, a thread of execution, and/or the like. Still further, results of acts of the methodologies can be stored in a computer-readable medium, displayed on a display device, and/or the like.

With reference now to FIG. 4, an exemplary methodology 400, executed at a mount, that facilitates positioning and/or orienting a mobile computing device is illustrated. The methodology 400 starts at 402, and at 404 a command signal is received from a mobile computing device. The command signal indicates a direction of movement of the mobile computing device and a velocity of movement of the mobile computing device in the specified direction. For example, the command signal can be received by a microcontroller of the mount. At 406, a drive signal is transmitted to a motor responsive to receipt of the command signal, wherein the microcontroller can transmit the drive signal. The drive signal can be a PWM signal that is configured to cause the motor to rotate in the direction and with the velocity indicated in the command signal. At 408, a mechanical linkage is driven by the motor based upon the drive signal. The driving of the mechanical linkage causes the mobile computing device to be moved in the direction indicated in the command signal and at the velocity indicated in the command signal. The methodology 400 completes at 410.

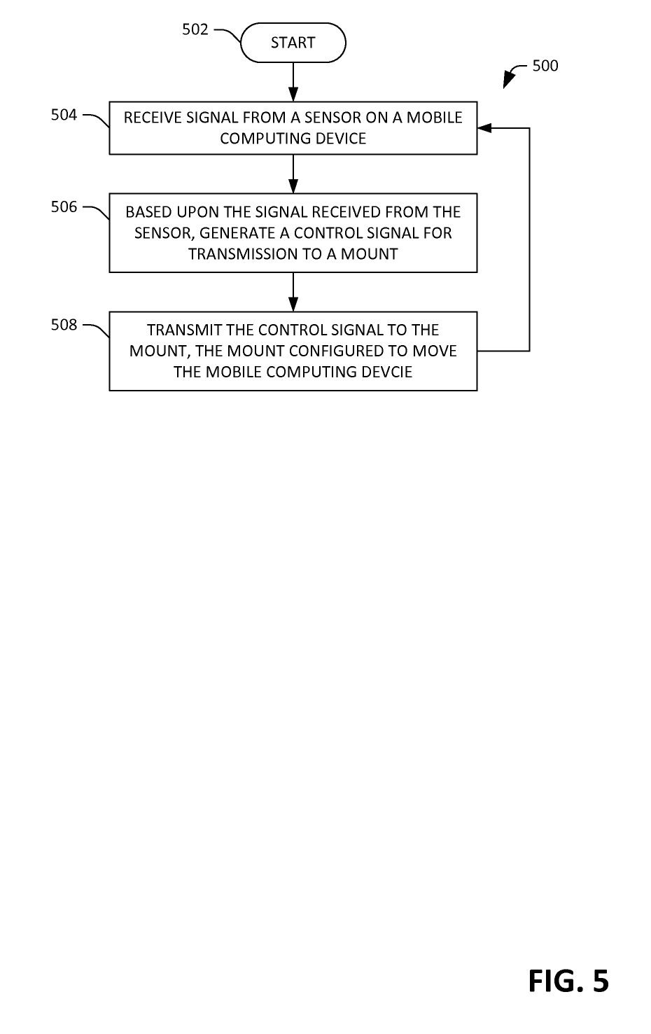

With reference now to FIG. 5, an exemplary methodology 500 that facilitates controlling operation of a mount is illustrated, wherein the methodology 500 is executed by a mobile computing device. The methodology 500 starts at 502, and at 504, a signal is received from a sensor on a mobile computing device. At 506, based upon the signal received from the sensor, a control signal is generated for transmission to a mount upon which the mobile computing device is mounted. For example, the control signal can be encoded in an audio signal. In another example, the control signal can be transmitted by way of a wireless connection between the mobile computing device and the mount. At 508, the control signal is transmitted to the mount, wherein the mount is configured to move the mobile computing device in accordance with the control signal. The methodology may then return to 504, where the process continues.

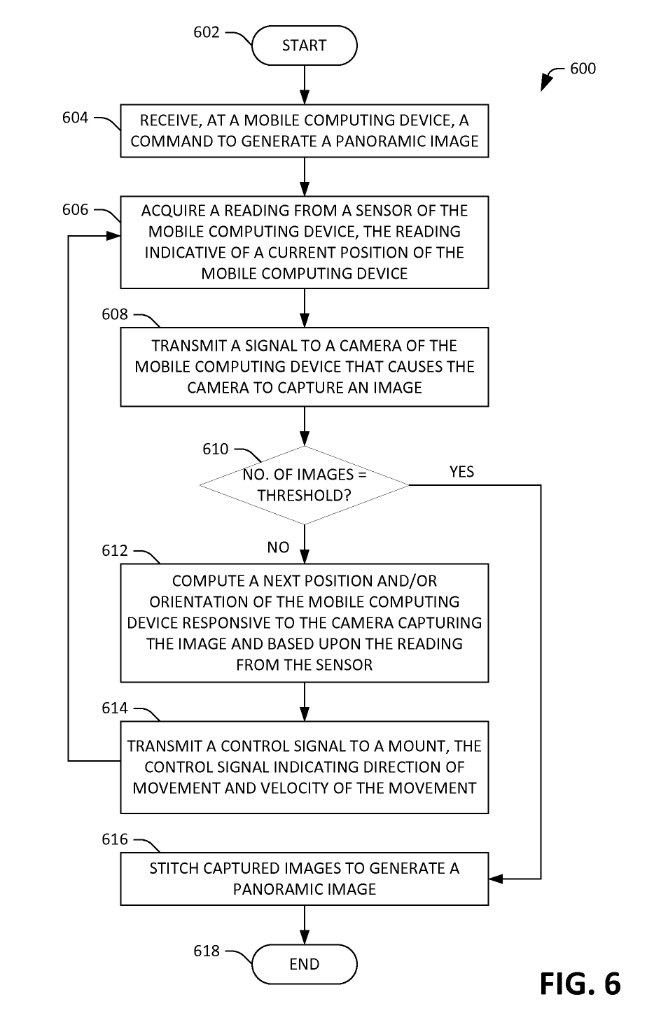

With reference to FIG. 6, an exemplary methodology 600 for generating a panoramic image is illustrated, wherein the methodology 600 is executed by a mobile computing device. The methodology 600 starts at 602, and at 604, a command to generate a panoramic image is received at the mobile computing device. In an example, the command can be received subsequent to the mobile computing device being stabilized in a mount.

At 606, a reading is acquired from a sensor of the mobile computing device, where the reading is indicative of the current position and/or orientation of the mobile computing device. The sensor can be a positional sensor, an inertial sensor, an image sensor, or the like. At 608, a signal is transmitted to a camera of the mobile computing device that causes the camera to capture an image. The image can be saved in computer readable storage of the mobile computing device and/or computer-readable storage that is accessible to the mobile computing device (e.g., cloud storage).

At 610 a determination is made regarding whether a threshold number of images have been captured (e.g., whether a threshold number of images to generate a panoramic image have been captured). If it is determined that more images are to be captured to generate the panoramic image, then at 612, a next position and/or orientation of the mobile computing device is computed, wherein the next position and/or orientation is the position and/or orientation of the mobile computing device that allows the camera to capture another image that will be used to generate the panoramic image. The next position and/or orientation is computed based upon, for example, the reading acquired from the sensor at 606. At 614, a control signal is transmitted to a mount, wherein the control signal indicates the direction of movement and a velocity of the movement. As described previously, a pan motor and/or a tilt motor drives a mechanical linkage of the mount to cause the mobile computing device to be tilted or panned in a direction and with a velocity indicated in the command signal. The methodology then returns to 606, wherein the acts can be repeated to capture another image for use when generating the panoramic image.

When at 610 it is determined that the number of images captured by the camera is sufficient to generate the panoramic image, then the methodology proceeds to 616, where captured images are stitched together to generate a panoramic image. The methodology completes at 618.

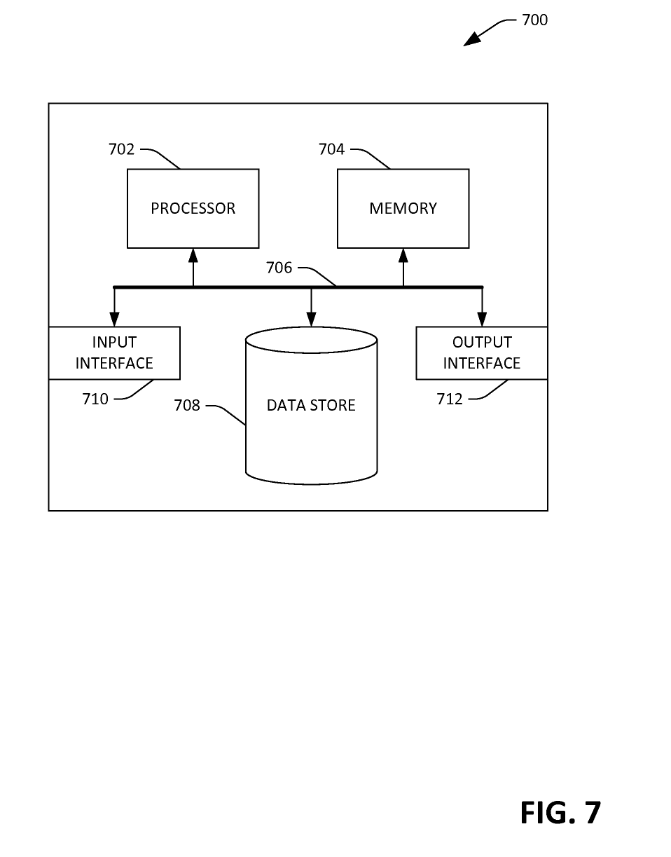

Referring now to FIG. 7, a high-level illustration of an exemplary computing device 700 that can be used in accordance with the systems and methodologies disclosed herein is illustrated. For instance, the computing device 700 may be the mobile computing device 104. By way of another example, the computing device 700 can represent the mount 102 or portions thereof. The computing device 700 includes at least one processor 702 that executes instructions that are stored in a memory 704. The instructions may be, for instance, instructions for implementing functionality described as being carried out by one or more components discussed above or instructions for implementing one or more of the methods described above. The processor 702 may access the memory 704 by way of a system bus 706. In addition to storing executable instructions, the memory 704 may also store command signals, images, sensor signals, etc.

The computing device 700 additionally includes a data store 708 that is accessible by the processor 702 by way of the system bus 706. The data store 708 may include executable instructions, images, command signals, sensor signals, etc. The computing device 700 also includes an input interface 710 that allows external devices to communicate with the computing device 700. For instance, the input interface 710 may be used to receive instructions from an external computer device, from a user, etc. The computing device 700 also includes an output interface 712 that interfaces the computing device 700 with one or more external devices. For example, the computing device 700 may display text, images, etc. by way of the output interface 712.

It is contemplated that the external devices that communicate with the computing device 700 via the input interface 710 and the output interface 712 can be included in an environment that provides substantially any type of user interface with which a user can interact. Examples of user interface types include graphical user interfaces, natural user interfaces, and so forth. For instance, a graphical user interface may accept input from a user employing input device(s) such as a keyboard, mouse, remote control, or the like and provide output on an output device such as a display. Further, a natural user interface may enable a user to interact with the computing device 700 in a manner free from constraints imposed by input device such as keyboards, mice, remote controls, and the like. Rather, a natural user interface can rely on speech recognition, touch and stylus recognition, gesture recognition both on screen and adjacent to the screen, air gestures, head and eye tracking, voice and speech, vision, touch, gestures, machine intelligence, and so forth.

Additionally, while illustrated as a single system, it is to be understood that the computing device 700 may be a distributed system. Thus, for instance, several devices may be in communication by way of a network connection and may collectively perform tasks described as being performed by the computing device 2000.

Various functions described herein can be implemented in hardware, software, or any combination thereof. If implemented in software, the functions can be stored on or transmitted over as one or more instructions or code on a computer-readable medium. Computer-readable media includes computer-readable storage media. A computer-readable storage media can be any available storage media that can be accessed by a computer. By way of example, and not limitation, such computer-readable storage media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray disc (BD), where disks usually reproduce data magnetically and discs usually reproduce data optically with lasers. Further, a propagated signal is not included within the scope of computer-readable storage media. Computer-readable media also includes communication media including any medium that facilitates transfer of a computer program from one place to another. A connection, for instance, can be a communication medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio and microwave are included in the definition of communication medium. Combinations of the above should also be included within the scope of computer-readable media.

Alternatively, or in addition, the functionally described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

What has been described above includes examples of one or more embodiments. It is, of course, not possible to describe every conceivable modification and alteration of the above devices or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the spirit and scope of the appended claims. Furthermore, to the extent that the term “includes” is used in either the details description or the claims, such term is intended to be inclusive in a manner similar to the term “comprising” as “comprising” is interpreted when employed as a transitional word in a claim.

What is claimed is:

1. A mount that is configured to receive a mobile computing device that comprises a camera, the mount comprising:
a pan motor;
a pan linkage driven by the pan motor, the pan linkage, when driven by the pan motor, causes the mobile computing device to pan;
a mount communications interface that receives a control signal from the mobile computing device, the control signal indicating a direction of pan of the mobile computing device and a velocity of the pan; and
a microcontroller that is electrically coupled to the mount communications interface and the pan motor, the microcontroller receives the control signal from the mount communications interface and generates a drive signal based upon the control signal, the drive signal drives the pan motor such that the pan linkage pans the mobile computing device in the direction indicated by the control signal and at the velocity indicated by the control signal.

2. The mount of claim 1, the mobile computing device being a mobile telephone.

3. The mount of claim 1, the mobile computing device being a slate computing device.

4. The mount of claim 1, further comprising:
a tilt motor;
a tilt linkage driven by the tilt motor, the tilt linkage, when driven by the tilt motor, alters a tilt of the mobile computing device, the mount communications interface receives a second control signal from the mobile computing device, the second control signal indicating a direction of tilt of the mobile computing device and a velocity of the tilt, the microcontroller receives the second control signal from the mount communications interface and generates a second drive signal based upon the second control signal, the second drive signal drives the tilt motor such that the tilt linkage tilts the mobile computing device in the direction indicated by the second control signal and at the velocity indicated by the second control signal.

5. The mount of claim 1 further comprising a photovoltaic cell, at least one of the microcontroller or the mount communications interface powered by way of the photovoltaic cell.

6. The mount of claim 1, the pan motor being a servo motor.

7. The mount of claim 1, the mount communications interface comprises an audio-in port, the control signal received from the mobile computing device encoded as an audio signal.

8. The mount of claim 7, the audio signal being one of a predefined number of potential audio signals in a library.

9. The mount of claim 1 being free of any positional or inertial sensors.

10. A method executed at a mount that is configured to receive and position a mobile computing device, the mount comprises a microcontroller, a motor, and a mechanical linkage driven by the motor, the method comprising:
at the microcontroller, receiving a command signal from the mobile computing device, the command signal indicating a direction of movement of the mobile computing device and a velocity of movement of the mobile computing device in the direction;
transmitting, from the microcontroller, a drive signal to the motor responsive to receipt of the command signal; and
driving the mechanical linkage based upon the command signal, wherein the driving of the mechanical linkage causes the mobile computing device to be moved in the direction indicated in the command signal and at the velocity of movement indicated in the command signal, and wherein the driving of the mechanical linkage is performed by the motor responsive to the motor receiving the drive signal.

11. The method of claim 10, wherein the direction is one of a left or right pan of the mobile computing device.

12. The method of claim 10, wherein the direction is an up or down tilt of the mobile computing device.

13. The method of claim 10, the motor being a servo motor.

14. The method of claim 10, the mobile computing device being a mobile telephone that comprises a camera.

15. The method of claim 14, wherein the direction indicated in the control signal and the velocity indicated in the control signal facilitate creation of a panoramic image by way of multiple images captured by the camera.

16. The method of claim 10, wherein the command signal is encoded as an audio signal.

17. The method of claim 16, the audio signal comprising a left audio signal and a right audio signal, one of the left audio signal or the right audio signal being a data signal, the other of the left audio signal or the right audio signal being a clock signal.

18. The method of claim 10, wherein the mount is free of any positional or inertial sensors, and wherein the driving of the mechanical linkage is based solely upon the command signal.

19. The method of claim 10, the motor being free of a stop pin.

20. A mount that facilitates moving a mobile telephone in connection with generating a panoramic image, the mount comprising:
a pan servo motor;
a tilt servo motor;
a pan linkage driven by the pan servo motor, the pan linkage configured to pan the mobile telephone when driven by the pan servo motor;
a tilt linkage driven by the tilt servo motor, the tilt linkage configured to tilt the mobile telephone when driven by the tilt servo motor;
an audio-in port that receives:
a first control signal, the first control signal encoded as a first audio signal, the first control signal indicates a direction of pan of the mobile telephone and a velocity of the pan of the mobile telephone; and
a second control signal, the second control signal encoded as a second audio signal, the second control signal indicates a direction of tilt of the mobile telephone and a velocity of the tilt of the mobile telephone;
a microcontroller in electrical communication with:
the audio-in port;
the pan servo motor; and
the tilt servo motor, the microcontroller receives the first control signal and the second control signal from the audio-in port, the microcontroller generates a first drive signal for the pan servo motor based upon the first control signal and generates a second drive signal for the tilt motor based upon the second control signal, wherein the first drive signal causes the pan motor to drive the pan linkage such that the mobile telephone is panned in the direction of the pan and at the velocity of the pan indicated in the first control signal, and the second drive signal causes the tilt motor to drive the tilt linkage such that the mobile telephone is tilted in the direction of the tilt and at the velocity of the tilt indicated in the second control signal, and wherein the mount is free of any positional sensors or inertial sensors.
